(19) United States
(12) Patent Application Publication
(10) Pub. No.: US 2006/0161559 A1
(43) Pub. Date: Jul. 20, 2006

(54) Methods and systems for analyzing XML documents

(75) Inventors: Rajesh R. Bordawekar, Yorktown Heights, NY (US); Christian A. Lang, New York, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 11/037,617

(22) Filed: Jan. 18, 2005

(51) Int. Cl. G06F 7/00

(52) U.S. Cl. 707/100

(57) ABSTRACT

Methods and systems for analyzing XML documents. The system scans an XML document, identifies different dimensions that span the XML document and detects scoping relationships amongst them. The system uses the dimensional information to create a logical hierarchical scoped dimension analysis model, maps the logical XML tree to this model, and then implements the analytical method over the logical model. The logical model allows both structural features and numeric/non-numeric data to be used for analysis. The analytical method allows users to query irregular structural properties of the XML documents using the XPath navigational API.

### FIELD OF THE INVENTION

The present invention generally relates to analyzing XML documents and, more specifically, to mapping of the XML data to a scoped dimension analysis model and to execution of semi-structured queries on the mapped data.

### BACKGROUND OF THE INVENTION

Throughout the instant disclosure, numerals in brackets—[ ]—are keyed to the list of numbered references towards the end of the disclosure.

Since its inception as a language for large-scale electronic publishing, Extensible Markup Language (XML) has emerged as the lingua franca for portable data representation. As a derivative of SGML, XML has been designed to represent both structured and semi-structured data. XML's ability to succinctly describe complex information can also be used for specifying application meta-data. XML's popularity is evident from its use in a wide spectrum of application domains: from document publication, to computational chemistry, health care and life sciences, multimedia encoding, geology, and e-commerce. Increasing popularity of web-based business processes and the emergence of web services has led to further acceptance of XML.

However, despite XML's wide-spread use, currently there are very few tools for analyzing XML data. Generally, XML data can be analyzed in two ways: (1) as semantically-rich text documents, and (2) as domain-specific data formulated using XML's semi-structured data model. Current efforts in XML analysis generally belong to the first category and use information retrieval techniques (e.g., keyword text searching) for knowledge discovery from XML documents. Based on present knowledge, there is no known work that analyzes XML data using domain-specific information.

An example of domain-specific analysis in general is Online Analytical Processing (OLAP), which has been extensively used by decision support systems. Such analysis is used to detect and predict trends in non-volatile time-varying business data. An OLAP system models the input data as a logical multidimensional cube with multiple dimensions that provide the context for analyzing measures of interest. Traditionally, measures are numeric values (e.g., units of sales or total sale amount) associated with the business data. Data analysis usually involves dimensional reduction of the input data using various aggregation functions, e.g., statistical (median, variance, etc.), physical (center of mass), and financial (volatility). Most database vendors support similar aggregation functions along with dimensional operators such as, ROLLUP, GROUPBY, and CUBE.

While OLAP is an effective tool for evaluating hierarchical relationships in structured data, its applicability is currently restricted to well-formulated business data that can be mapped to the multi-dimensional OLAP model. This prevents application of several useful OLAP features, e.g., grouping based on common data properties, structured aggregation, and trend analysis, to XML data.

As such, there may be said to be three possible ways of using XML data in a data analysis system.

In a first approach, XML is used simply for external presentation of the OLAP results. The raw data is stored using either the relational (ROLAP) or the multi-dimensional (MOLAP) storage. Various data analysis operations (e.g., CUBE queries) are executed using the traditional multi-dimensional OLAP model.

In a second approach, input data is stored as XML documents. Relevant data is first extracted from the input XML documents using a XML processing language (e.g., XSLT, XQuery, or SQL/XML) and exported to the OLAP engine. The data analysis is still implemented using the multi-dimensional model. The results from the OLAP analysis may also be exported as XML documents.

Finally, a third approach uses XML both for data representation and processing. The data analysis engine represents the XML documents as trees using the tree-based, hierarchical, XML model and analyzes both the structure and the data values using an XML processing language.

Traditional OLAP uses a regular multi-dimensional model where multiple independent attributes called dimensions jointly define the context for the corresponding numeric measures. “Measures” are those attributes of the data model that are used as input to the aggregation operations. Dimensions can have sub-attributes called, members, that exhibit hierarchical non-recursive containment relationships (e.g., the time dimension can have the following hierarchy [in that a dimension can have more than one hierarchy with members]: year, quarter, month, days, and hours). Multi-dimensional OLAP is characterized by the following key features: (1) Input data organized into independent dimensions and numerical measures (e.g., using the star or snowflake schema on relational base tables), (2) Multi-dimensional array-like addressing of numeric measures, and (3) Computations dominated by structured aggregation operations over numerical measures: (a) across levels of individual dimensions and (b) across dimensions at the same level.

Online analytical processing of XML documents raises issues that are substantially different from the traditional multi-dimensional OLAP. XML analysis differs both in the underlying data model and the prospective query patterns. Differences in the data models are briefly discussed herebelow.

XML is a flexible text format derived from SGML. An XML document is a text document whose textual entities are scoped in a hierarchy of self-descriptive markup tags. XML can be used to develop different domain-specific vocabularies that can encode the domain content via semantic markups and encode inherent relationships among the content entities via markup hierarchies. The XML data model views an XML document as a tree in which the internal nodes correspond to elements (denoting the markup), the leaves correspond to the textual content, and the tree edges correspond to the relationships among content entities. Different axes in XML data can represent various relationships, e.g., containment (HAS-A) and subclass (IS-A) relationships.

For analytical purposes, internal nodes of an XML tree (i.e., elements) can be viewed as members of scoped dimensions, where the dimension scope is determined by their parent elements, and values of the leaves can be viewed as the corresponding measures. In this model, dimensions members are related to each other via XML's hierarchical structure. However, not all dimensions are mutually dependent, e.g., dimensions defined by unique siblings (and their subtrees) an independent within the scope of their parent dimension. Further unlike traditional OLAP, classification between dimensions and measures is not rigid. Any XML element can be associated with a set of attributes that provide additional information on that element. Such information could also be used for analysis purposes. In other words, some dimensions could also be analyzed as measures.

Unlike relational data, XML documents do not adhere to a rigid schema and can exhibit irregular structure. At the same time, all well-formed XML documents conform to an abstract XML tree whose nodes are ordered in an in-order, depth-first manner (called the document order). XML documents can have recursive hierarchies or hierarchies with different members. Thus, XML is an ideal representation of semi-structured data. The flexible structure of an XML document can be specified using a strongly-typed XML schema. Potentially, more than one XML instance document can map to an XML schema. Unlike the multi-dimensional OLAP, the context of a measure is defined by the hierarchy in which it is scoped. In an XML document, a measure attribute can appear in more than one contexts (or hierarchies). Therefore, an analytical operation over a measure in one context may not be applicable for the same measure in another context. Finally, since XML nodes are ordered in the document order, measures themselves could be semantically related by the order relationship.

The abstract tree to represent the XML document is addressed using the XPath navigational language [6]. XPath navigates the abstract XML tree via five distinct axes. These axes support navigation on the tree over explicit parent-child edges and implicit edges such as sibling edges. Hence, any node of an XML tree can be addressed in a multitude of ways. This is in contrast to the rigid array-based addressing in the OLAP data model.

Traditional OLAP involves analyzing only numeric measures (e.g., sales) of business data using aggregation functions. Since XML is increasing used for specifying non-business data (e.g., genome databases), it can have both numeric and non-numeric data (e.g., ATCG strings representing amino acid sequences) that need to be analyzed.

Differences in query patterns will now be briefly discussed.

The XML data model enforces a strict document ordering of XML nodes. The XML node ordering is exploited by the XML processing languages e.g., XPath, to support position-based queries on the XML tree, e.g., identify the first child of a node. Similar position-based queries could be used for analyzing ordered data sets whose ordering carries certain semantics. For example, consider an XML document that stores effects of a drug on a bio-metric parameter (e.g., white blood cell count) in a clinical drug study [8]. FIG. 5 represents the corresponding abstract XML tree. Typical order-dependent analytical queries on this document can include: (1) For each asthma drug, compare the blood cell count after every usage with the corresponding count for the healthy case, (2) Determine those drugs whose second usage results in the maximum change in the white blood cell count, or (3) For all asthma drugs, find the maximum variation in the white blood cell count after the second usage. Such queries are not supported by the traditional OLAP systems.

Typical relational OLAP operations such as GROUPBY, ROLLUP or CUBE group tuples of a relation based on values of its column attributes. In XML analysis, one can also group XML entities based on their structural attributes that encode entity relationships. Structural path attributes can be specified via XPath expressions or can use generalized tree patterns specified using regular path expressions.

Non-numeric (textual) measures could be used in two types of queries: (1) Structured queries which involve aggregation operations over strings, e.g., find the maximum or average length of the string measures, and (2) approximate queries which involve substring or string pattern matching. An example application is searching for similar images in MPEG-7 [15]. The MPEG-7 standard is based on XML and allows the storage of image and video features as strings. Similarity searching on images and videos is thereby transformed into similarity searching on strings.

In a traditional OLAP system, slicing involves reducing dimensions of a data cube and then projecting the data cube using the reduced dimension. Equivalently, an XML tree could be sliced over its independent dimensions by selectively eliminating the subtrees in those dimensions. Similarly, the dicing operation identifies and removes subtrees based on values derived from structural properties (e.g., depth of an XML node) or node values.

In the traditional OLAP system, what-next analysis has been extensively used to predict future trends. The what-next analysis involves modifying values of certain measures and studying its impact on the overall data trends by using different aggregation functions. In XML analysis, one can evaluate the impact of relationships by modifying the structure of XML data. For example, consider an XML document describing the structure of an organization where the organization has many divisions, each division has many departments, each department has many groups, and each group consists of several employees. Each division has a fixed budget which gets percolated down the organization hierarchy according to a certain formula. Consider an analyst who wants to find out the impact of the organization hierarchy on a group's budget. She can rerun the budget computation by moving the group to another departmental hierarchy. Existing OLAP systems can not support such structural analytics.

To summarize the reach of conventional efforts, current work in using XML for OLAP applications involves using XML for representing external data. Based on current knowledge, no one has investigated exploiting XML's tree model for analytical purposes. Recently, Pedersen et al. have been exploring the integration of XML data with the traditional OLAP processing [10]. Jensen et al. describe how to specify multi-dimensional OLAP cubes over source XML data [12]. Recently, several researchers have proposed extensions to relational databases for supporting complex OLAP functionalities. Hurtado and Mendelzon [7] and Jagadish et al. [9] have investigated OLAP processing over heterogeneous hierarchies defined over relational data. Chaudhuri et al. [2] have studied approximate query processing in the context of aggregation queries. Barbara and Sullivan have proposed Quasi-Cubes, for computing approximate answers in multidimensional cubes [1].

The approaches just described use approximation to reduce computation time over precise data. However, a need has been recognized in connection with addressing source XML data which is inherently imprecise. Further, Lerner and Shasha recently proposed extensions to SQL for supporting order-dependent queries (AQuery) [11]. Carmel et al. have investigated approximate searching of XML documents using structural templates (called XML fragments) [3]. Navarro and Baeza-Yates have proposed a model to query documents by their content and structure [12]. However, their solutions are not applicable for analyzing XML documents.

Accordingly, a growing need has been recognized in connection with surpassing the reach of conventional efforts in the analysis of XML documents and in related or constituent matters.

### SUMMARY OF THE INVENTION

In accordance with at least one presently preferred embodiment of the present invention, there is broadly contemplated a system and method for analytical processing of semi-structured data, e.g., XML documents.

As such, one aspect of the invention broadly provides a system for pre-processing semi-structured XML documents to identify the scoped dimensions that span the document under evaluation. The pre-processing involves parsing the XML document under evaluation, identifying dependent and independent dimensions, and storing the dimensional information into an auxiliary data structure. This data structure is then used to map the XML document to a scoped dimension analysis model whose hierarchy is determined by the scoped dimensions. This logical hierarchical model adapts the standard XML data model for analysis purposes.

Another aspect of the present invention provides a method for querying the semi-structured features of the XML documents. The method operates on the logical hierarchical model populated by the data from the source XML document. The method supports (1) hierarchical projection over scoped dimensions based on either the structure or the values of the XML data, (2) structural analysis operations such as structural trend analysis, and (3) semi-structured queries such as position (or order)-dependent queries, queries on non-numeric measures, and hierarchical queries that use structural- or value-based approximation.

In summary, one aspect of the invention provides a system for analyzing XML documents, the system comprising: an arrangement for parsing an XML document by node; an arrangement for initializing the parsed node; an arrangement for storing values associated with the parsed node; and an arrangement for analyzing the parsed document.

Another aspect of the invention provides a method of analyzing XML documents, the method comprising the steps of: parsing an XML document by node; initializing the parsed node; storing values associated with the parsed node; and analyzing the parsed document.

Furthermore, an additional aspect of the invention provides a program storage device readable by machine, tangibly embodying a program of instructions executed by the machine to perform method steps for analyzing XML documents, the method comprising the steps of: parsing an XML document per node; initializing the parsed node; storing values associated with the parsed node; and analyzing the parsed document.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 shows a block diagram of a generic XML analysis system.

FIG. 2 shows an XML tree.

FIG. 3 illustrates a scoped dimensional hierarchy corresponding to the XML tree of FIG. 2.

FIG. 4 shows the XML tree being mapped to the scoped dimension analysis model.

FIG. 5 shows an XML tree representing data from a clinical-study application.

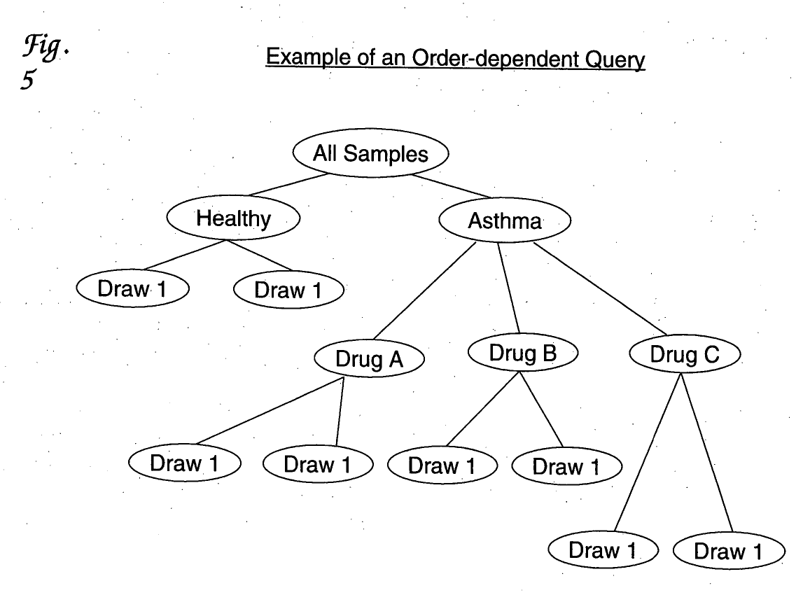

### DESCRIPTION OF PREFERRED EMBODIMENTS

Some background information of interest may be found in the copending and commonly assigned U.S. Patent Application entitled “Method and System for Supporting Structured Aggregation Operations on Semi-Structured Data”, which is filed concurrently with the instant application and which is hereby fully incorporated by reference as if set forth in its entirety herein.

One embodiment of the present invention encompasses a logical hierarchical analysis model, called the scoped dimension analysis model, for analyzing semi-structured data such as XML documents. In another embodiment of the present invention, the scoped dimension analysis model is preferably integrated in a system with an XML parser and an XML query processor. For an XML document, the system first parses the document, identifies scoped dimensions that span the document and then populates the analysis model using nodes from the parsed XML document. In another embodiment of the present invention, the scoped dimension analysis model is used for implementing queries over semi-structured features of the XML document.

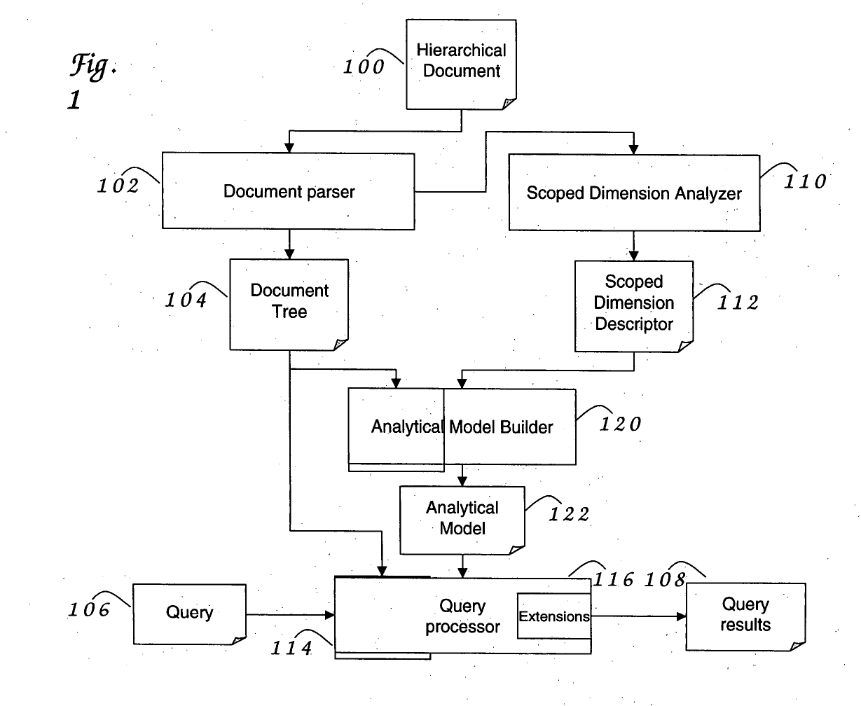

The disclosure now turns to a discussion of the key features of the analysis system. For the purpose of discussion, the schematic illustrated in FIG. 1 will be used. The system first parses an XML document (100) using a SAX- or DOM-based parser (102). As the document is being parsed, the parser invokes a scoped dimension analyzer (110) to identify dependent and independent dimensions and their scopes. The scoped dimension analyzer then preferably proceeds as follows:
1. In an XML document, it operates only on XML Element and Attribute nodes. It neglects the remaining nodes.
2. Starting from the document root, every XML Element or Attribute node is marked as a dimension with the tag-name as its dimension name.
3. Other than the document root, every dimension is marked as a sub-dimension within the scope of its parent dimension (i.e., the dimension defined by the parent element of the current element or attribute node).
4. Within the scope of a dimension, if a sub-dimension with a particular name exists, the sub-dimension is not added to a temporary data structure, called the scoped dimension descriptor (112). Else, the sub-dimension is added as a child dimension within the scope of its parent dimension to create a scoped dimension hierarchy.

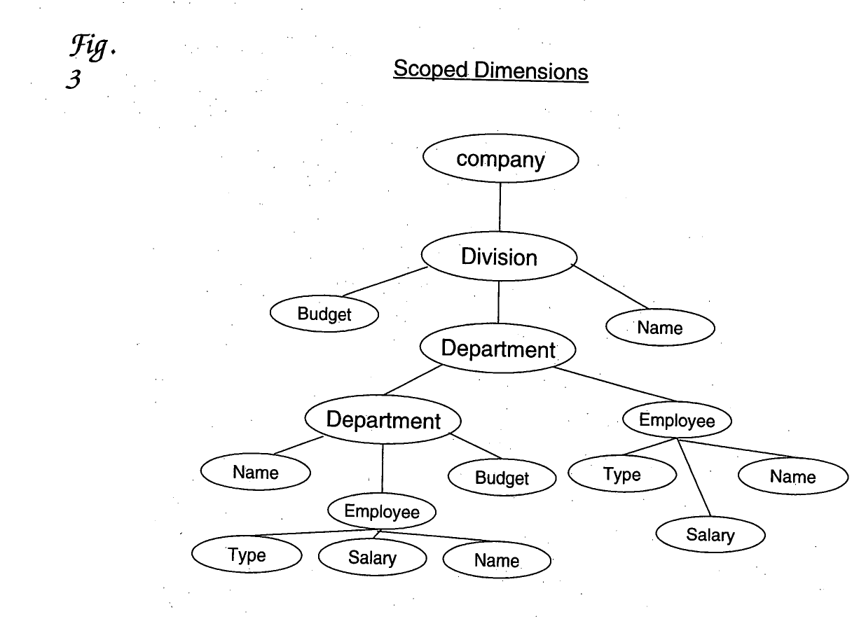

All unique dimensions in a scoped dimension are considered independent within the scope of that dimension. Further, all dimensions that have the same parent scope are considered independent over the scope of the entire XML document. For example, with brief reference to FIG. 3, which shows a scoped dimensional hierarchy, the dimension Employee is independent over the entire document, whereas the dimension Department is independent in the scope of its parent dimension only. Further, all dimensions are dependent on their ancestor dimensions.

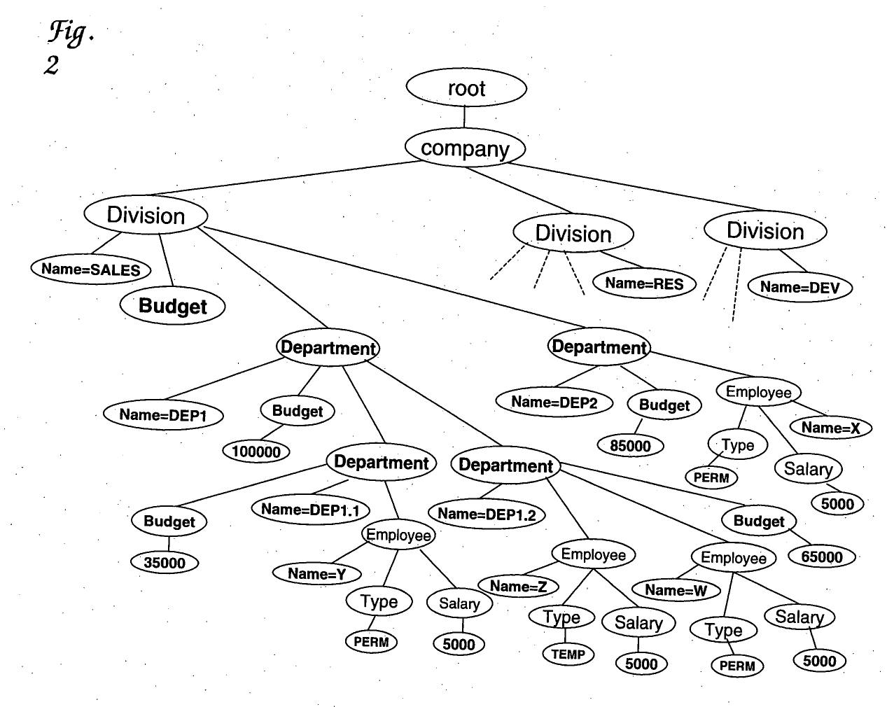

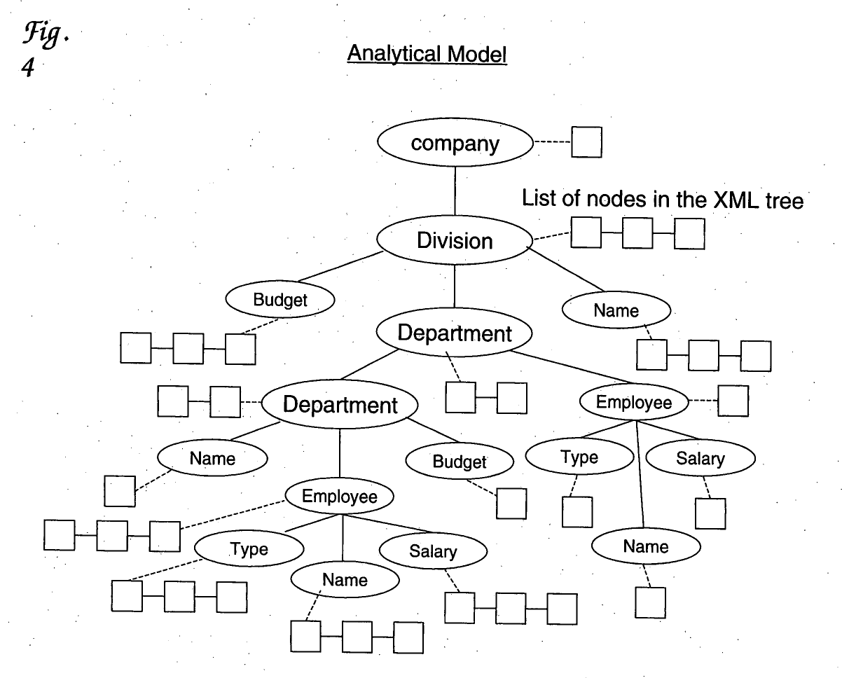

Once the document is parsed, the scoped dimension descriptor (112) and parsed document tree (104) (generated by the parser, and a detailed illustrative exanple of which is shown in FIG. 2) are passed to the analytical model builder (120). The builder generates the analytical model (122) by first recreating the dimension hierarchy and then assigning the XML Element and Attribute nodes to the appropriate nodes in the dimensional hierarchy. All text nodes are also assigned to their parent element or attribute nodes (note that these parent nodes form the dependent dimensions of the document). By way of brief reference, FIG. 4 illustrates the populated analytical model: each node in the analytical model points to a list of nodes, sorted using the XML's document order (depth-first pre-order numbering). The document tree 104 is also modified to insert references back to the analytical model. Note that this approach does not require transformations of the source data as in the case of analyzing relational data.

The disclosure now turns to a discussion of an execution of analysis methods over the analytical model. As FIG. 1 illustrates, while executing an XML query (106) towards yielding results (108), the query processor (116) loads both the XML document tree and the corresponding analytical model. The XML query processor (116) preferably uses XPath API (XPath is a language for addressing parts of an XML document, designed to be used by both XSLT and XPointer; a general discussion of XPath API may be found in the XPath Standards Document [6] to address and navigate through the XML tree. The analytical model (122) is mainly used for processing analysis queries. Contemplated herein is the execution of three types of queries: (1) Projection Queries, (2) Structural Analytics Queries, and (3) Semi-structured Queries. Such queries could be specified using a high-level XML processing language such as XQuery [6].

As discussed earlier, projection queries involve selecting nodes depend on a specified criteria. In accordance with at least one embodiment of the present invention, two main types of projection are enabled; one type is based on the dimensional specification, while the other is based on the values of certain measurable features of the XML document.

The scoped dimension descriptor (112) classifies dimensions into dependent and independent dimensions. The first projection approach selects all nodes that are spanned by a particular independent dimension and projects the XML tree without the selected nodes. This approach is called as hierarchical slicing. The selection criteria can be further refined by using XPath-based predicates [see 6]. For example, the XML document illustrated in FIG. 1 could be sliced along the Employee dimension. The second approach involves selecting those nodes that are spanned by an dimension within a given scope. For example, the current XML document could be sliced along the Department dimension that is spanned within another Department dimension. This approach is called as hierarchical trimming. Nodes could also be selected using a value-based selection criteria. Values may be numeric, such as salary of employees, or non-numeric, such as names of employees. Values can also measure certain structural features of the XML documents. For example, it can select only those employees whose organizational hierarchy contains two or more departments. This approach is called as hierarchical dicing. Execution of such projection queries involves traversing the scoped dimension analysis model, choosing the node that represents the dimension, and then traversing the associated node list to select the nodes that need to be eliminated.

The second class of queries concerns structural analytics, in particular, forecasting future trends that could be caused by possible changes in entity relationships. As an illustration, consider the example presented earlier, where an analyst wants to find out the impact of reorganization on a particular group's budget. To implement such queries, the query processor (116) first creates a view of the analytical model to match the required structural change and re-assigns the node lists to their appropriate parent nodes. The query processor (116) then performs the necessary computation (e.g., budget computation) on the new view. Such structural analytics queries could be either written using a high-level XML query language such as XQuery [6], or specified using a graphical tool.

The scoped dimension analytical model is also suitable for answering queries that analyze semi-structured features of the XML document. For example, consider the clinical drug study example that studies the effect of a drug on a bio-metric parameter. Suppose a researcher wants to study the effects of increased drug usage on a certain bio-metric parameter at regular intervals (i.e., after every 4 hours). In this example, the increased drug usage could be first simulated using a structural forecasting technique. The order-based query could be then executed over the modified view.

It is to be understood that the present invention, in accordance with at least one presently preferred embodiment, includes an arrangement for parsing an XML document by node, an arrangement for initializing the parsed node, an arrangement for storing values associated with the parsed node, and an arrangement for analyzing the parsed document. Together, these elements may be implemented on at least one general-purpose computer running suitable software programs. They may also be implemented on at least one integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirely herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### References

1. D. Barbara and M. Sullivan, Quasi-Cubes: Exploiting Approximations in Multidimensional Databases. ACM SIGMOD Record, 26(3): 12-17, 1997.

2. S. Chaudhuri, G. Das, and V. Narasayya, A robust, optimization-based approach for approximate answering of aggregate queries. In Proceedings of the 2001 ACM SIGMOD international conference on Management of data, pages 295-306. ACM Press, 2001.

3. D. Carmel, Y. S. Maarek, M. Mandelbrod, Y. Mass, and A. Soffer, Searching XML documents via XML fragments. In Proceedings of ACM SIGIR Conference on Research and Development in Information Retrieval, pages 151-158, 2003.

4. S. Chaudhuri and U. Dayal, An Overview of Data Warehousing and OLAP Technology. Data Mining and Knowledge Discovery, 26(1):65-74, 1997.

5. Z. Chen, H. V. Jagadish, L. V. S. Lakshmanan, and S. Paparizos, From Tree Patterns to Generalized Tree Patterns: On Efficient Evaluation of XQuery In Proceedings Is of the 29th International Conference on Very Large Data Bases (VLDB), pages 237-248, September 2003.

6. World Wide Web Consortium. W3C Architecture Domain: XML, www.w3c.org/xml. Online Documents.

7. J. Gray, S. Chaudhuri, A. Bosworth, A. Layman, D. Reichart, M. Venkatrao, F. Pellow, and H. Pirahesh, Data Cube: A Relational Aggregation Operator Generalizing Group-By, Cross-Tab and Sub-Totals. Data Mining and Knowledge Discovery, 1(1):29-53, March 1997.

8. C. A. Hurtado and A. O. Mendelzon. Reasoning about Summarizability in Heterogeneous Multidimensional Schemas. In Proceedings of the International Conference on Database Theory, 2001.

9. N. Huyn, Data Analysis and Mining in the Life Sciences. ACM SIGMOD Record, 30(3):76-85, 2001.

10. H. V. Jagadish, L. V. S. Lakshmanan, and D. Srivastava, What can Hierarchies do Data Warehouses?, In Proceedings of the International Conference on Very Large Data Bases (VLDB), pages 530-541, September 1999.

11. M. R. Jensen, T. H. Moller, and T. B. Pedersen, Specifying OLAP Cubes on XML Data. In Proceedings of the 13th International Conference on Scientific and Statistical Database Management, pages 18-20, July 2001.

12. A. Lerner and D. Shasha, A Query: Query Language for Ordered Data, Optimization Techniques and Experiments, In Proceedings of the 29th International Conference on Very Large Data Bases (VLDB), pages 213-224, September 2004.

13. G. Navarro and R. Baeza-Yates, Proximal Nodes: A Model to Query Document Databases by Content and Structure. ACM Transactions on Information Systems, 15(4):400-435, 1997.

14. D. Pedersen, K. Riis, and T. B. Pedersen, Query Optimization for OLAP-XML Federations. In Proceedings of DOLAP 2002, ACM Fifth International Workshop on Data Warehousing and OLAP, pages 57-64, November 2002.

15. Moving Pictures Experts Group (MPEG), MPEG Standards.

What is claimed is:

1. A system for analyzing XML documents, the system comprising:
an arrangement for parsing an XML document by node;
an arrangement for initializing the parsed node;
an arrangement for storing values associated with the parsed node; and
an arrangement for analyzing the parsed document.

2. The system according to claim 1, wherein the arrangement for initializing the parsed node comprises: an arrangement for creating a tree node for the parsed node;
an arrangement for extracting dimensional information;
an arrangement for linking to at least one child node if the parsed node is a parent; and
an arrangement for establishing the parsed node as the root of a tree when the parsed node is not a parent.

3. The system according to claim 2, wherein the arrangement for extracting dimensional information comprises:
an arrangement for recording path information associated with the parsed node;
an arrangement for identifying at least one dimension associated with the path of each node.

4. The system according to claim 3, wherein the path information recorded by said recording arrrangement comprises at least one of: hierarchy information and tag information.

5. The system according to claim 3, wherein said identifying arrangement comprises:
an arrangement for assigning at least one root dimension when the parsed node does not have a parent node;
an arrangement for assigning at least one scoped dimension when the parsed node has a parent node.

6. The system according to claim 5, wherein said arrangement for assigning a scoped dimension comprises:
an arrangement for identifying unique tags amongst nodes with a common parent; and
an arrangement for assigning unique tags as dimensions scoped within the dimension of the parent node.

7. The system according to claim 1, wherein said arrangement for storing values associated with the parsed node comprises:
an arrangement for storing at least one scoped dimension in an auxiliary data structure;
an arrangement for taking values associated with the parsed node and associating such values with a dimensional hierarchy generated by ancestors of the parsed node;
an arrangement for storing such values in the auxiliary data structure.

8. A method of analyzing XML documents, said method comprising the steps of:
parsing an XML document by node; initializing the parsed node;
storing values associated with the parsed node; and
analyzing the parsed document.

9. The system according to claim 8, wherein said step of initializing the parsed node comprises:
creating a tree node for the parsed node;
extracting dimensional information;
linking to at least one child node if the parsed node is a parent; and
establishing the parsed node as the root of a tree when the parsed node is not a parent.

10. The system according to claim 9, wherein step of extracting dimensional information comprises:
recording path information associated with the parsed node;
identifying at least one dimension associated with the path of each node.

11. The system according to claim 10, wherein the path information recorded by said recording arrrangement comprises at least one of: hierarchy information and tag information.

12. The system according to claim 10, wherein said identifying step comprises:
assigning at least one root dimension when the parsed node does not have a parent node;
assigning at least one scoped dimension when the parsed node has a parent node.

13. The system according to claim 12, wherein said step of assigning a scoped dimension comprises:
identifying unique tags amongst nodes with a common parent; and
assigning unique tags as dimensions scoped within the dimension of the parent node.

14. The system according to claim 8, wherein said step of storing values associated with the parsed node comprises:
storing at least one scoped dimension in an auxiliary data structure;
taking values associated with the parsed node and associating such values with a dimensional hierarchy generated by ancestors of the parsed node; and
storing such values in the auxiliary data structure.

15. The method according to claim 8, wherein:
said step of storing values comprises creating and populating an auxiliary data structure per document;
said analyzing step comprises analyzing each document using an unstructured user query over the auxiliary data structure.

16. The method according to claim 15, wherein said step of analyzing each document comprises at least one of:
selecting portions of a document according to the scoped dimensions and projecting the remaining document as a tree;
selecting portions of a document according to values of its properties and projecting the remaining document as a tree; and
performing future trend analysis to study the effect of structural changes.

17. The method according to claim 15, wherein said step of creating and populating the auxiliary data structure comprises the steps of:
identifying scoped dimensions;
storing the scoped dimensions together with the node values in the auxiliary data structure.

18. The method according to claim 15, wherein said analyzing step comprises:
identifying nodes in the XML document using tree-patterns extracted from the user query;
filtering the identified nodes based on the auxiliary data structure; and
executing the unstructured user query on the filtered nodes.

19. The method according to claim 9, wherein said filtering step comprises at least one of:
employing node context information; and
using the auxiliary data structure to obtain node context information related to the user-specified scoped dimensions.

20. A program storage device readable by machine, tangibly embodying a program of instructions executed by the machine to perform method steps for analyzing XML documents, said method comprising the steps of:
parsing an XML document per node;
initializing the parsed node;
storing values associated with the parsed node; and
analyzing the parsed document.
